(19) United States
(12) Patent Application Publication
(10) Pub. No.: US 2005/0015210 A1
(43) Pub. Date: Jan. 20, 2005

(54) Computer-implemented method and system for estimating facility water consumption

(75) Inventors: Alissa Kendall, Ann Arbor, MI (US); Bill Gaines III, Northville, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 10/621,163

(22) Filed: Jul. 16, 2003

(51) Int. Cl. G01F 17/00; G01N 11/00; G01F 23/00

(52) U.S. Cl. 702/50

(57) ABSTRACT

Embodiments of the present invention include a computer-implemented method and system for estimating water consumption within a facility (e.g. residential, industrial, educational, medical, environmental, business, government facilities, etc.). More specifically, embodiments of the present invention estimate facility operation-specific water consumptions based on user-defined data. Another aspect of the present invention automatically generates a graphical water table for the facility. As an alternative to real-world or “current” data, users may specify hypothetical facility and operational data and characteristics as part of a “what-if” scenario to identify opportunities for improvement or optimization of facility water consumption. Notably, user-defined data and characteristics may be modified, updated or supplemented at any time. “What-if” and ROI analyses are also supported.

### BACKGROUND OF THE INVENTION

1. Field of the Invention

The present invention relates to estimating water consumption, and more specifically to a computer-implemented method and system for estimating facility water consumption.

2. Background Art

Conventional methodologies for estimating facility water consumption, and creating a complete facility water balance are difficult, costly and do not effectively assist facility water planners in identifying the best opportunities for reducing water consumption, thereby reducing the total cost of water to support the facility.

More specifically, conventional methodologies for estimating facility water consumption include hiring expert consultants to evaluate a facility's water consumption habits at a particular point in time, in an effort to generate a water balance for the facility based on the evaluation. Although this brute-force methodology is certainly capable of producing an accurate water balance based on existing data, the water balance is fixed in time and does not allow planners to efficiently update/modify the underlying data to obtain an updated water table. To do so, facility water planners typically have to re-hire the expert consultant, or worse, start from scratch. In addition, these fixed-in-time water consumption analyses do not enable facility water planners to effectively conduct “what-if” scenarios with respect to facility architecture and operations to quickly (and cheaply) identify the best opportunities for reducing or otherwise optimizing facility water consumption.

What is needed is a method and system that will overcome these and other drawbacks associated with prior art water planning and analysis methods.

### SUMMARY OF THE INVENTION

Embodiments of the present invention include a computer-implemented method and system for estimating water consumption within a facility (e.g. residential, industrial, educational, medical, environmental, business, government facilities, etc.). More specifically, embodiments of the present invention estimate facility operation-specific water consumptions based on user-defined data. Another aspect of the present invention automatically generates a graphical water table for the facility. As an alternative to real-world or “current” data, users may specify hypothetical facility and operational data and characteristics as part of a “what-if” scenario to identify opportunities for improvement or optimization of facility water consumption. Notably, user-defined data and characteristics may be modified, updated or supplemented at any time, resulting in an instantaneous update in corresponding operation or facility water consumptions.

Another aspect of the present invention identifies the relative impact that different water consumption adjustments will have on the overall water balance can be considered. In this manner, a wide variety of return-on-investment (ROI) analyses may be implemented.

Yet another aspect of the present invention enables a user to identify unusual water consumption rates within a facility. More specifically, this feature of the present invention enables a user to compare estimated or “typical” water consumption rates with actual consumption rates (where such data is available).

According to a system and method embodiment of the present invention, a computer system for estimating water consumption for a facility is provided. The system comprises one or more computers operably programmed and configured to: (i) receive input defining a plurality of values or characteristics for one or more water-consuming operations within the facility, (ii) estimate and output an annual water consumption for each of the water-consuming operations based on the plurality of values or characteristics, and (iii) automatically create and display a water table for the facility based on the annual water consumption for each of the water-consuming operations. The system may additionally be configured to display a calculator for estimating and outputting the annual water consumption for one or more of the water-consuming operations.

Water consuming operations may include but are not limited to domestic activities, lawn irrigation activities, fire protection systems, assembly operations, phosphate coating, e-coating, cooling tower systems and boiler systems.

### BRIEF DESCRIPTION OF THE DRAWINGS

FIG. 1 is a block flow diagram illustrating an example methodology for implementing one embodiment of the present invention;

FIG. 2 illustrates an example graphical user interface (GUI) for selecting a facility type in accordance with one aspect of the present invention;

FIG. 3 illustrates an example GUI for receiving a variety of known or estimated values or characteristics relating to a facility's water consumption;

FIG. 4 illustrates an example GUI including a domestic water use calculator in accordance with one aspect of the present invention;

FIG. 5 illustrates an example GUI including a lawn watering use calculator in accordance with one aspect of the present invention;

FIG. 6 illustrates an example GUI including a fire water system use calculator in accordance with one aspect of the present invention;

FIG. 7 illustrates an example GUI including a water consumption calculator for leak test and car wash operations in accordance with one aspect of the present invention;

FIG. 8 illustrates an example GUI including a water consumption calculator for phosphate and electrocoat operations in accordance with one aspect of the present invention;

FIG. 9 is an example GUI including a cooling tower use calculator in accordance with one aspect of the present invention;

FIG. 10 is an example GUI including a boiler system/powerhouse water consumption calculator in accordance with one aspect of the present invention; and

FIG. 11 illustrates a graphical facility water balance and water cost calculator in accordance with one aspect of the present invention.

### DETAILED DESCRIPTION OF THE PREFERRED EMBODIMENTS

Methodology

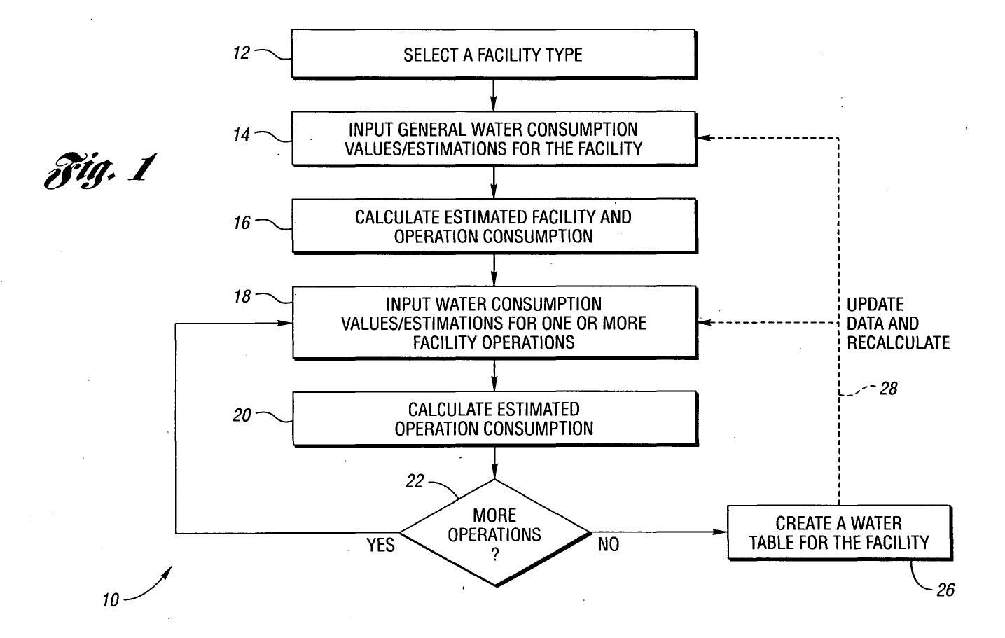

FIG. 1 is a block flow diagram illustrating an example methodology 10 for implementing or otherwise using the present invention. Notably, the content or arrangement of the block flow diagram illustrated in FIG. 1 may be modified or adapted to best-fit a particular implementation of the present invention.

In accordance with the example implementation 10, one or more computers are operably programmed and configured to receive input selecting a type of facility (e.g., assembly plant, engine/transmission plant, stamping plant, casting plant, office building, etc.), as represented in block 12. See below for an example GUI illustrating this aspect of the present invention. In an alternate embodiment, the present invention may be customized or otherwise specialized for estimating water consumption for a single facility type. Those of ordinary skill in the art will recognize, however, that the functionality and usefulness of the present invention transcends all types of facilities that consume or otherwise utilize water—including but not limited to residential, industrial, educational, medical, environmental, business and governmental facilities.

As represented in block 14, the computer receives input defining certain general water consumption values/estimations and/or attributes for the facility. See below for an example GUI illustrating this aspect of the present invention. Notably, input may be provided in a variety of manners and formats including but not limited to user-input, data import and/or electronic data transfer with legacy systems or other external applications. Based on the input reflected in block 14, the computer calculates an initial water consumption estimation for the facility and/or one or more facility operations (e.g. domestic water use, etc.), as represented in block 16.

As represented in block 18, water consumption estimations/values and related attributes (e.g., units, etc.) are input for one or more facility operations. Facility operations include any water consumption activity within or otherwise associated with the facility. For example, an automotive manufacturing or assembly facility might include operations such as domestic lawn care, fire system, plant operations, cooling towers, boiler system, etc. See below for example GUIs illustrating this aspect of the present invention.

Upon inputting water consumption estimations/values and related attributes for each facility operation, the computer preferably calculates a total estimated water consumption for that facility, as represented in block 20. As represented by decision point 22 and arrow 24, steps 18 and 20 may be repeated for each facility operation that consumes water.

When water consumption estimations/values and related attributes for each facility operation have been input (blocks 18, 20 and 22), the computer creates a water table for the facility as represented in block 26. See below for an example GUI illustrating this aspect of the present invention.

As represented by dashed line 28, water consumption estimations/values and related attributes may be modified or updated at any time. This feature of the present invention enables the accuracy of estimations and the water table to increase as more accurate data is collected and input or otherwise revised. In addition, this feature of the present invention supports “what if” analyses to see what impact certain modifications in facility or operation water consumption estimations/values and related attributes have on overall facility water consumption and/or the water table (see FIG. 11).

System Implementation

A system embodiment of the present invention may be implemented in software with application utilities including but not limited to Microsoft Visual Basic, and executed on stand-alone computers (e.g., personal computers, notebooks, handheld devices, etc.) or in a networked computing environment (e.g., local area network, intranet, Internet, etc.).

In the following detailed description of a system implementation of the present invention, a variety of example graphical user interfaces (GUIs) are provided to enable those of ordinary skill in the art to make and use features of the present invention. Notably, those of ordinary skill in the art recognize that functionality associated with the example GUIs disclosed or otherwise discussed herein may be provided or otherwise supported in adapted or modified embodiments within the scope of the present invention. For illustrative purposes only, certain aspects and/or embodiments of the present invention are described in association with the automotive industry. Those of ordinary skill in the art will recognize, however, that the functionality and usefulness of the present invention transcends all types of facilities that consume or otherwise utilize water—including but not limited to residential, industrial, educational, medical, environmental, business and governmental facilities.

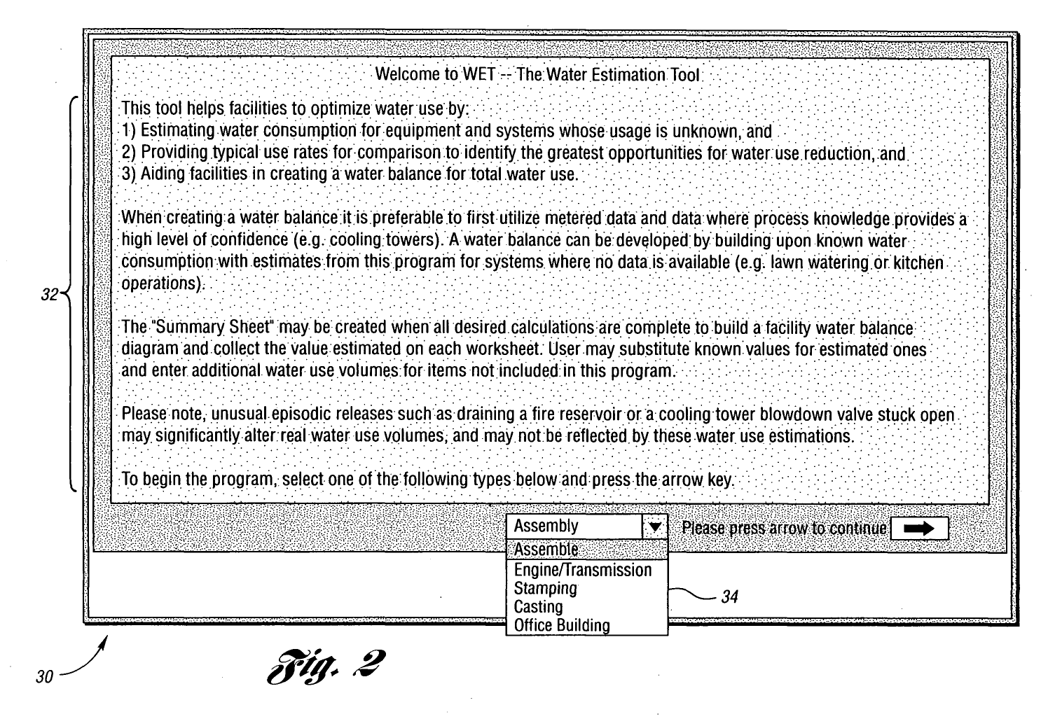

FIG. 2 is an example GUI 30 for initiating a facility water analysis in accordance with one embodiment of the present invention. In addition to providing a general overview and instruction 32 for using a software implementation of the present invention, GUI 30 includes a drop-down menu 34 enabling a user to specify a particular facility type to analyze (e.g., assembly plant, engine/transmission plant, stamping plant, casting plant, office building, etc.). Of course, the types of facilities that may be analyzed with the present invention are not limited to those shown in drop-down menu 14. Other types of facilities may include (but are not limited to) residential, industrial, educational, medical, environmental, business and governmental facilities.

According to one embodiment of the present invention, the nature of selection 34 will dictate the combination of user interfaces presented for defining known or estimated water consumption and related attributes (e.g. units, etc.) for different operations within or otherwise associated with the facility. Table 1 identifies an example combination of interfaces provided to a user depending on facility type selection 34. For example, a user selecting “Office Building” from drop-down menu 34 would be presented with one or more interfaces for domestic, lawn care, fire system, and boiler system water consumption sources. A user selecting “Engine Plant” from drop-down menu 34, however, would be presented with one or more interfaces for domestic, lawn care, fire system, plant operations, cooling towers and boiler system water consumption sources.

TABLE 1

| Enterprise | Sources of Water Consumption | | | | | |
|---|---|---|---|---|---|---|
| Type | (User Interfaces) | | | | | |
| (User | | Lawn | Fire | Plant | Cooling | Boiler |
| Selection) | Domestic | Care | System | Operations | Towers | System |
| Assembly | X | X | X | X | — | X |
| Plant | | | | | | |
| Engine | X | X | X | X | X | X |
| Plant | | | | | | |
| Stamping | X | X | X | X | — | X |
| Plant | | | | | | |
| Casting | X | X | X | X | X | X |
| Plant | | | | | | |
| Office | X | X | X | — | — | X |
| Building | | | | | | |

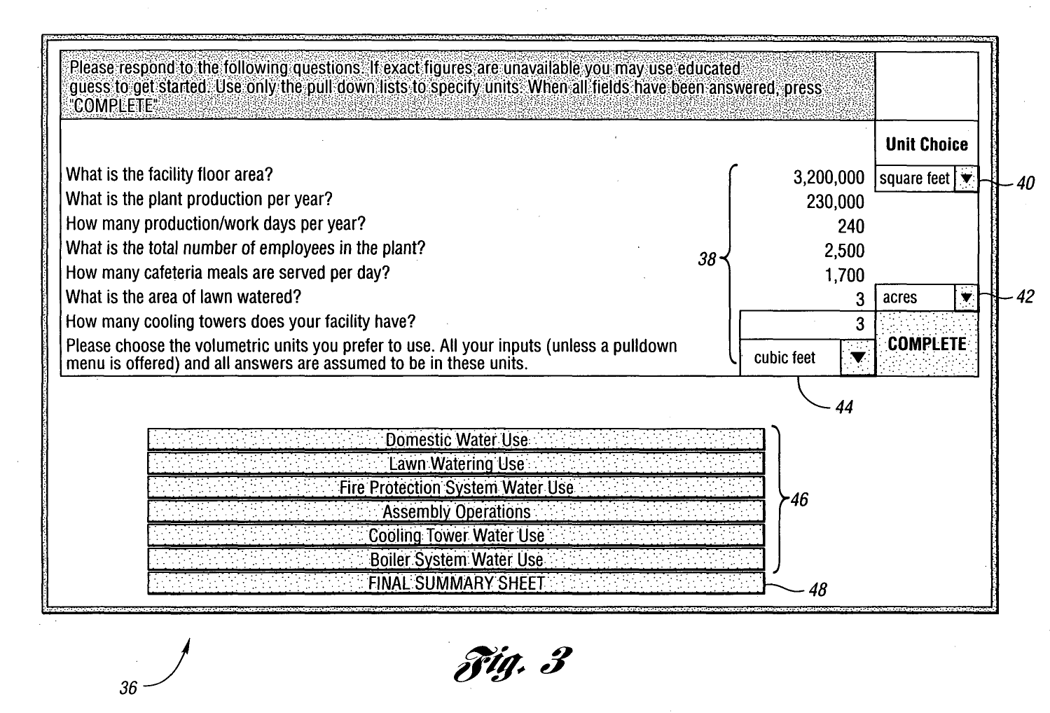

FIG. 3 is an example GUI 36 for receiving a variety of known or estimated values or characteristics 38 relating to a facility's water consumption. Unit selection drop-down menus 40, 42 and 44 enable unit flexibility in data entry. As will be discussed in greater detail below, input 38 may be included in computations for calculating or estimating water consumption rates for facility operations and/or creating a water balance for the enterprise.

Selection of buttons 46 initiate a plurality of water consumption calculators for operations within or otherwise associated with the facility. Of course, selections 46 are not limited to those shown and may include calculators for determining or estimating water consumption for any operation within or otherwise associated with the facility. This feature of the present invention is described in greater detail below.

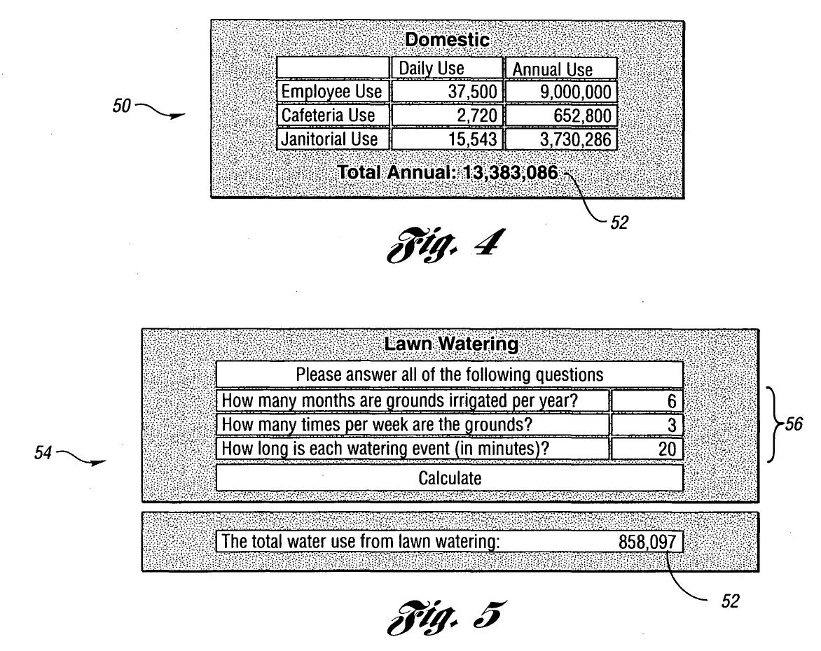

FIG. 4 is an example GUI including a domestic water use calculator 50 in accordance with one aspect of the present invention. This feature of the present invention may be utilized to receive data 52 associated with facility domestic water consumption (e.g., employee use, cafeteria use, janitorial use, etc.) and estimate a total annual domestic water consumption value 52 for the facility. Preferably, one or more initial consumption estimates are automatically provided in calculator 50 based on the data 38 referred to with respect to FIG. 3. Notably, a user may modify or update any initial consumption estimates, yielding an updated total annual domestic water consumption value 52.

Table 2 includes example calculations executed by the domestic water use calculator 50. Of course, the calculations provided in Table 2 may be modified or supplemented to best-fit a particular implementation of the present invention.

TABLE 2

| Value | Calculation |
|---|---|
| Cafeteria | = number meals * 1.6 (gallons/meal) * conversion to |
| Water Use | preferred units * production days per year |
| Sanitary | = X (gal/day) * number employees * conversion to |
| Water Use | preferred units * prod days per year |
| | (X = 15 for assembly, 20 for engine/trans, 30 for |
| | casting and stamping) |
| Janitorial | = plant area * conversion to sq ft * (17/3500) |
| Water Use | (gal/sq ft/day) * prod days per year |

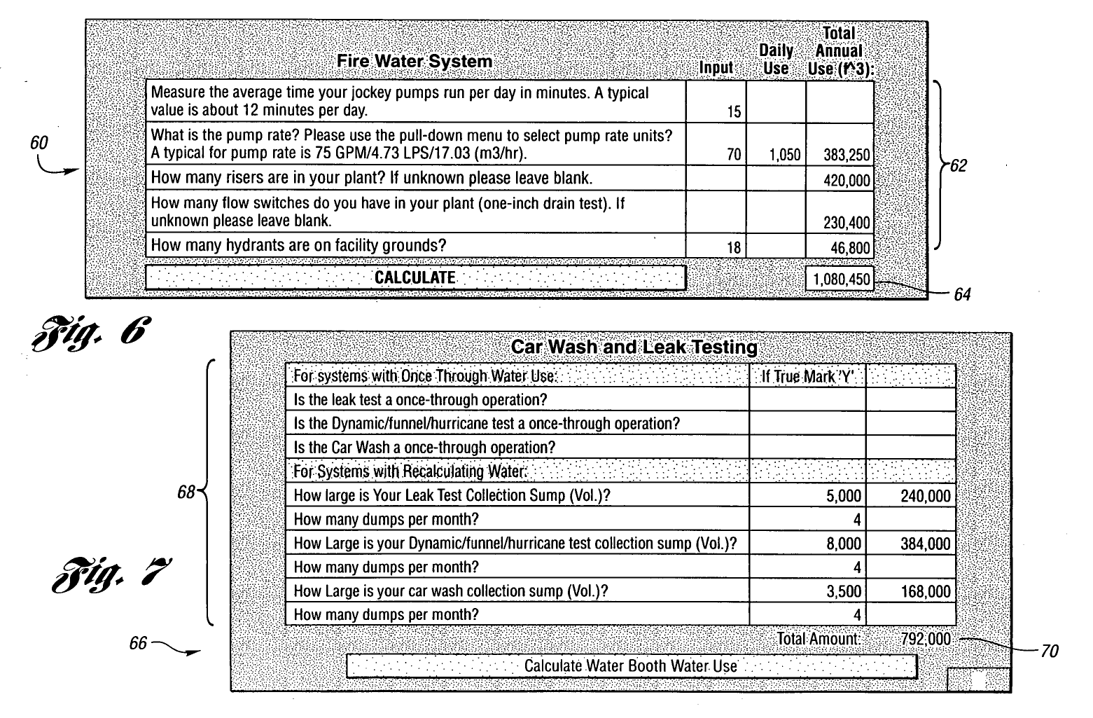

FIG. 5 is an example GUI including a lawn watering use calculator 54 in accordance with one aspect of the present invention. This feature of the present invention may be utilized to receive data 56 associated with lawn watering (e.g. irrigation months per year, irrigations per week, watering event length, etc.), and estimate a total annual lawn watering consumption value 58 for the facility. Notably, a user may modify or update any initial consumption estimates, yielding an updated total annual lawn watering consumption value 58.

Table 3 includes example calculations executed by the lawn watering use calculator 54. Of course, the calculations provided in Table 3 may be modified or supplemented to best-fit a particular implementation of the present invention.

TABLE 3

| Value | Calculation |
|---|---|
| Total | = area watered * conv. to sq ft * 0.0042 |
| Irrigation | (gal/sq ft/min) * min/event * events/week * 1/7 |
| Use | (weeks/days) * 30.4 (ave days/month) * months/ |
| | year |

FIG. 6 is an example GUI including a fire water system use calculator 60 in accordance with one aspect of the present invention. This feature of the present invention may be utilized to receive data 62 associated with the facility fire water system, and estimate a total annual fire water system consumption value 64 for the facility. Notably, a user may modify or update any initial consumption estimates, yielding an updated total annual fire water system consumption value 64.

Table 4 includes example calculations executed by the fire water system use calculator 60. Of course, the calculations and values provided in Table 4 may be modified or supplemented to best-fit a particular implementation of the present invention.

TABLE 4

| Value | Calculation |
|---|---|
| Daily Jockey | = minutes running/day * pump rate |
| Pump | |
| Annual | = jockey pump daily * 365 |
| Jockey Pump | |
| Riser | If number of risers are known: |
| Tests/Two | = number of risers * 175 GPM * 7.5 minutes/ |
| Inch Drain | (conversion to preferred units) * 4 tests/year |
| Tests | If number of risers are unknown: |
| | = plant area * conversion to sqft/40,000 * 175 GPM * 7.5 |
| | minutes/(conversion to preferred |
| | units) * 4 tests/year |
| Flow Switch | If number of flow switches are known: |
| Tests/One | = number of flow switches * 120 * 1.5/ |
| Inch Drain | (conversion to preferred units) * 8 tests/year |
| Tests | If number of flow switches are unknown: |
| | = plant area * conversion to sqft/40,000 * 2 |
| | (flow switches/area) * 120 GPM * 1.5/ |
| | (conversion to preferred units) * 8 tests/year |
| Hydrant | = number of hydrants * 2600 gallons/test/ |
| Tests | (conversion to preferred units) |

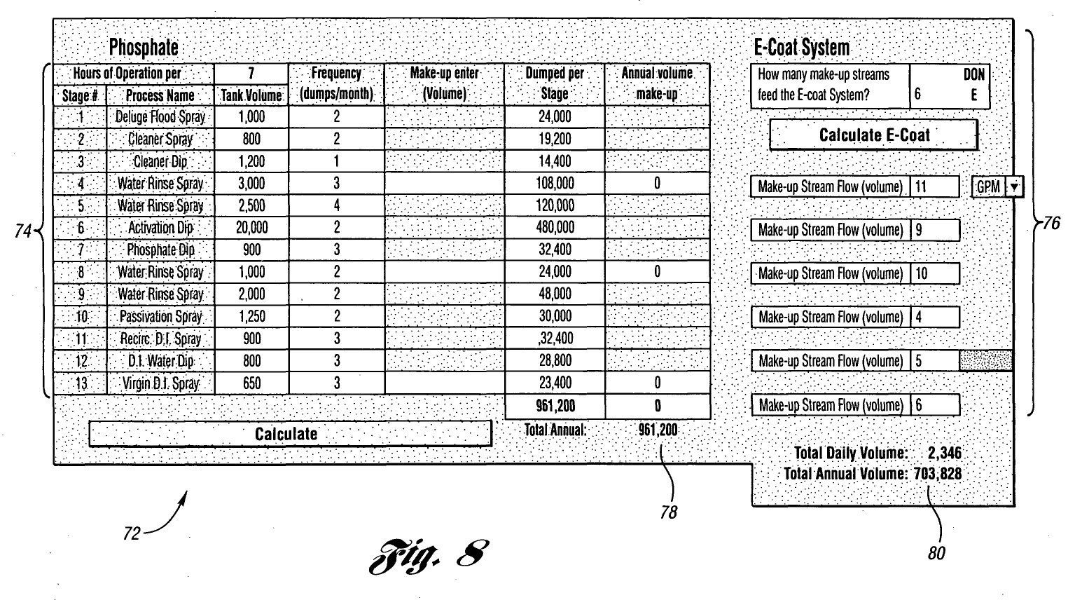

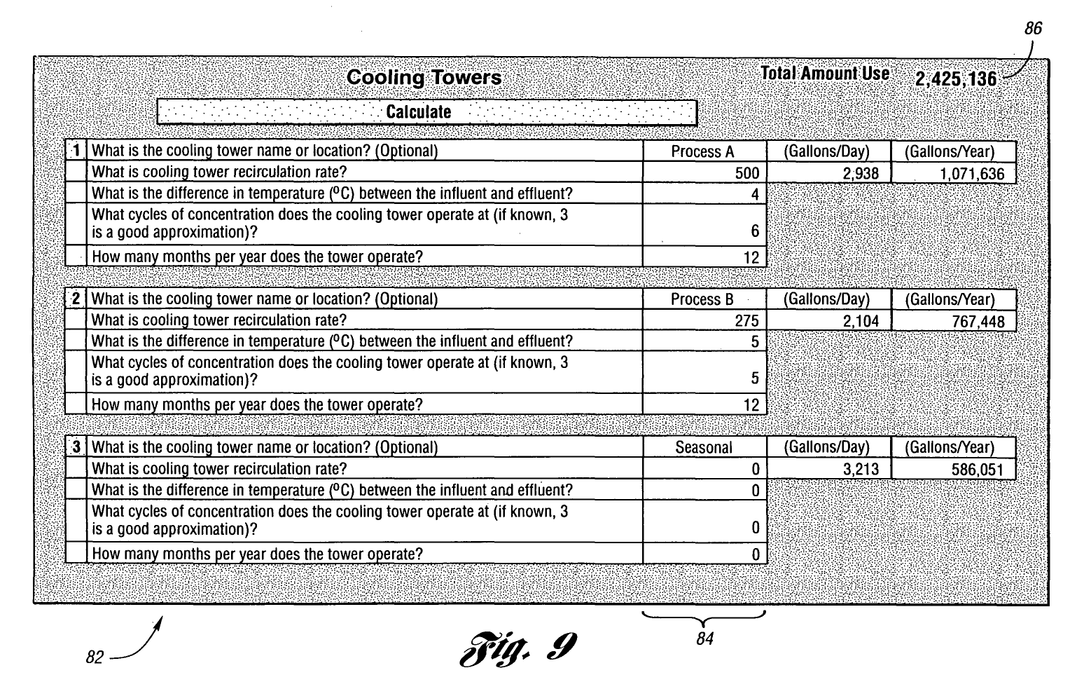

FIGS. 7 and 8 are example GUIs for calculating assembly operation water consumption in the automotive industry. Notably, the industry-specific illustrated and described with respect to FIGS. 7 and 8 are for illustrative purposes only. Water consumption for an unlimited number of industrial operations may be calculated or estimated within the scope of the present invention.

FIG. 7 includes an example water consumption calculator 66 for leak test and car wash operations. Calculator 66 may be utilized to receive information 68 associated with the leak test and car wash operations, and estimate a total annual leak test and car wash consumption value 70 for the facility. Notably, a user may modify or update any consumption estimates, yielding an updated total annual domestic water consumption value 70.

Table 5 includes example calculations executed by the leak test and car wash operations water use calculator 60. Of course, the calculations and values provided in Table 5 may be modified or supplemented to best-fit a particular implementation of the present invention.

TABLE 5

| | Value | Calculation |
|---|---|---|
| Once Through | Soak | = production vehicles per year * 1/40 |
| Operations | Test/ | (vehicles tested/vehicles produced) * 1998 |
| | Static | gal/vehicle * (conversion to |
| | Leak Test | preferred units) |
| | Hurricane | = production vehicles per year * 617.96 |
| | Tunnel/ | gal/vehicle * (conversion to |
| | Dynamic | preferred units) |
| | Leak Test | |
| | Car Wash | = production vehicles per year * 695 |
| | | gal/vehicle * conversion to preferred |
| | | units |
| Recirculating | Soak | = tank volume * dumps/month * 12 |
| Systems | Test/ | months/yr |
| | Static | |
| | Leak Test | |
| | Hurricane | = tank volume * dumps/month * 12 |
| | Tunnel/ | months/yr |
| | Dynamic | |
| | Leak Test | |
| | Car Wash | = tank volume * dumps/month * 12 |
| | | months/yr |

FIG. 8 includes an example water consumption calculator 72 for phosphate and electrocoat operations. Calculator 72 may be utilized to receive information 74 and 76 associated with the phosphate and e-coat operations, respectively, and estimate total annual/daily phosphate and electrocoat operation consumptions 78 and 80, respectively. Notably, a user may modify or update any consumption estimates, yielding updated total consumption values 78 and/or 80.

Table 6 includes example calculations executed by the phosphate conversion coating and electrocoating consumption calculator 72. Of course, the calculations and values provided in Table 6 may be modified or supplemented to best-fit a particular implementation of the present invention.

TABLE 6

| Value | | Calculation |
|---|---|---|
| Phosphate | Make-Up Water | = hours of operation * make-up flow |
| Conversion | Calculation | (vol/min) * 60 (min/hr) * production |
| Operations | | days per year |
| | Annual Water- | = tank vol * dumps/month * 12 |
| | Use By Dumping | (months/yr) |

| | |
|---|---|
| Electrocoat Operations | = sum of all flows (vol/min) * 60 |
| | (min/hr) * hours of operation/day |

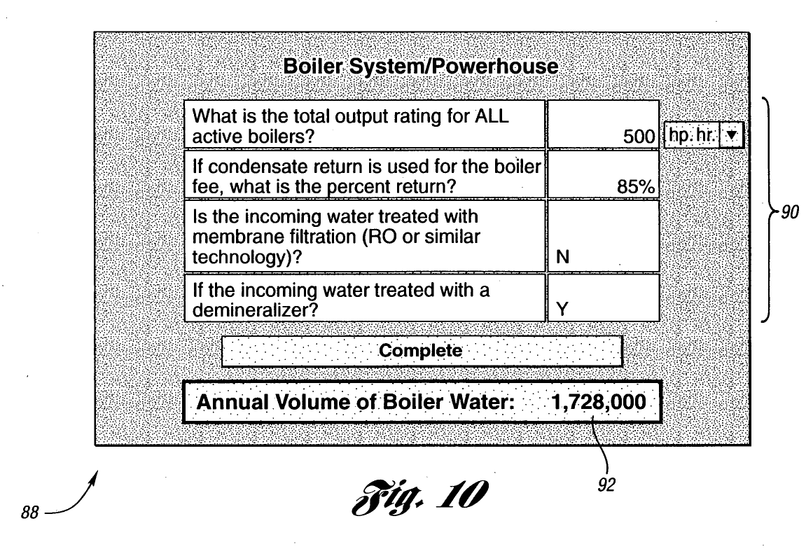

FIG. 9 is an example GUI including a cooling tower use calculator 82 in accordance with one aspect of the present invention. This feature of the present invention may be utilized to receive data 84 associated with facility cooling towers, and estimate a total annual cooling tower consumption value 86 for the facility. Consumptions per day and per year for each individual cooling tower may also be provided. Notably, a user may modify or update any initial consumption estimates, yielding an updated total annual cooling tower water consumption value 86.

Table 7 includes example calculations executed by the cooling tower use calculator 82. Of course, the calculations and values provided in Table 7 may be modified or supplemented to best-fit a particular implementation of the present invention.

TABLE 7

| Value | Calculation |
|---|---|
| Annual | = 0.00085 * Qc * dT * CC/(CC − 1) * 1440 |
| Cooling | (min/day) * months of operation/yr * 30.4 |
| Tower | (days/month) |
| Consumption | Where: |
| | Qc = recirculation rate |
| | CC = Cycles of Concentration |
| | dT = change in temperature (from inlet to outlet) |
| | 85% of total cooling is assumed to be evaporative, |
| | and 15% from sensible cooling |

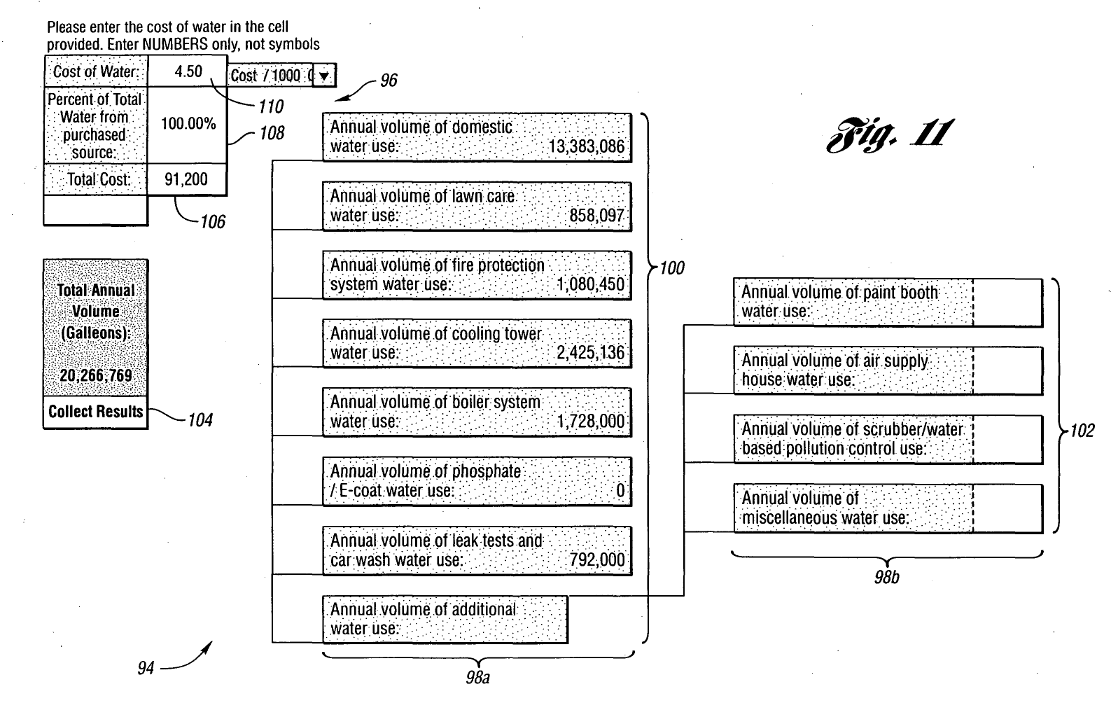

FIG. 10 is an example GUI including a boiler system/powerhouse water consumption calculator 88 in accordance with one aspect of the present invention. This feature of the present invention may be utilized to receive data 90 associated with facility boiler systems/powerhouses, and estimate a total annual boiler system/powerhouse consumption value 92 for the facility. Notably, a user may modify or update any initial consumption estimates, yielding an updated total annual boiler system/powerhouse water consumption value 92.

Table 8 includes example calculations executed by the boiler system/powerhouse water consumption calculator 88. Of course, the calculations and values provided in Table 8 may be modified or supplemented to best-fit a particular implementation of the present invention.

TABLE 8

| Value | Calculation |
|---|---|
| Boiler Water | = total output rating * conversion to hp.hr. * 4 |
| Consumption | (gal water/hp.hr) * (1 − percent condensate return/ |
| | 100) * 24 hours/day * production days/year * filtration |
| | factor * conversion to preferred units |
| | The filtration factor accounts for water |
| | consumption due to a reject stream if membrane |
| | filtration is used for pre-treatment. |

FIG. 11 illustrates a graphical facility water table 94 and water cost calculator 96 in accordance with one aspect of the present invention. In accordance with a preferred embodiment of the present invention, facility water table 94 is automatically created based on data and information collected and computed via GUIs such as those illustrated in FIGS. 2-10. Those of skill in the art will recognize that graphical water table 94 may be generated in a variety of computer-assisted or computer-implemented fashions. For example, water table 94 may be generated utilizing one or more Microsoft Visual Basic macro programs in conjunction with a Microsoft Excel spreadsheet for data collection, processing and display. More specifically, Microsoft Office 2000 integrates Visual Basic 5.0 as “Visual Basic for Applications” (VBA) functionality for creating macros interfacing with Microsoft office applications including Microsoft Excel.

Facility water table 94 may include a one or more tiers 98a and 98b of water consumption sources, each tier having one or more instances 100 of water consumption. Preferably, additional data-entry fields (e.g. 102) are provided for user-defined or miscellaneous sources of water consumption not covered or otherwise considered with respect to the various water consumption calculators provided (some examples 46 are collectively shown in FIG. 3). A total annual facility water consumption 104 is also provided. Water cost calculator 96 calculates the total cost 106 of purchased water 108 at a user-defined water cost 110.

Notably, values and attributed input into GUIs and calculators such as those illustrated in FIGS. 2-11 may be modified or updated at any time. This feature of the present invention enables the accuracy of the various water consumption estimations and the water table 94 to increase as more accurate or additional data is collected and input or otherwise revised. In addition, this feature of the present invention supports “what if” analyses to see what impact (e.g. cost and water savings) certain modifications in facility or operation water consumption estimations/values and related attributes have on overall facility water consumption.

For example, the relative impact that different water consumption adjustments will have on the overall water balance can be considered. In this manner, a wide variety of return-on-investment (ROI) analyses may be implemented.

Yet another aspect of the present invention enables a user to identify unusual water consumption rates within a facility. More specifically, this feature of the present invention enables a user to compare estimated or “typical” water consumption rates with actual consumption rates (where such data is available). Large discrepancies might suggest a water consumption problem within the facility (e.g., over-consumption, under-consumption, etc.), requiring further investigation.

For example, if the cooling tower calculator 82 illustrated in FIG. 9 estimates that cooling tower 1 should have a water consumption rate of 2,938 gallons/day, yet a field test indicates that the actual water consumption of cooling tower 1 is over 4,000 gallons/day, water consumption at cooling tower 1 should be investigated.

While the best mode for carrying out the invention has been described in detail, those familiar with the art to which this invention relates will recognize various alternative designs and embodiments for practicing the invention as defined by the following claims.

1. A computer-implemented system for estimating water consumption for a facility, the system comprising one or more computers operably programmed and configured to: (i) receive input defining a plurality of values or characteristics for one or more water-consuming operations within the facility, (ii) estimate and output an annual water consumption for each of the water-consuming operations based on the plurality of values or characteristics, and (iii) automatically create and display a water balance for the facility based on the annual water consumption for each of the water-consuming operations.

2. The system of claim 1 wherein the one or more computers are additionally operably programmed and configured to display a calculator for estimating and outputting the annual water consumption for one or more of the water-consuming operations.

3. The system of claim 1 wherein the water consuming operations include domestic activities.

4. The system of claim 1 wherein the water consuming operations include lawn irrigation activities.

5. The system of claim 1 wherein the water consuming operations include fire protection systems.

6. The system of claim 1 wherein the water consuming operations include assembly operations.

7. The system of claim 1 wherein the water consuming operations include phosphate conversion coating.

8. The system of claim 1 wherein the water consuming operations include electrocoating.

9. The system of claim 1 wherein the water consuming operations include cooling tower systems.

10. The system of claim 1 wherein the water consuming operations include boiler systems.

11. The system of claim 1 wherein the one or more computers are additionally operably programmed and configured to display a calculator for estimating and outputting the cost for annual facility water consumption.

12. A computer-implemented method for estimating water consumption for a facility, the method comprising (i) receiving input defining a plurality of values or characteristics for one or more water-consuming operations within the facility, (ii) estimating and outputting an annual water consumption for each of the water-consuming operations based on the plurality of values or characteristics, and (iii) automatically creating and displaying a water balance for the facility based on the annual water consumption for each of the water-consuming operations.

13. The method of claim 12 wherein the water consuming operations include domestic activities.

14. The method of claim 12 wherein the water consuming operations include lawn irrigation activities.

15. The method of claim 12 wherein the water consuming operations include fire protection systems.

16. The method of claim 12 wherein the water consuming operations include assembly operations.

17. The method of claim 12 wherein the water consuming operations include phosphate conversion coating.

18. The method of claim 12 wherein the water consuming operations include electrocoating.

19. The method of claim 12 wherein the water consuming operations include cooling tower systems.

20. The method of claim 12 wherein the water consuming operations include boiler systems.

21. The method of claim 12 further comprising estimating and outputting the cost for annual facility water consumption.

22. The method of claim 12 wherein one or more of the values or characteristics are hypothetical.

23. The method of claim 12 additionally comprising comparing an estimated water consumption rate for a water-consuming operation to an actual water consumption rate for the water consuming operation to identify a potential water consumption problem within the facility.
